(19) United States
(12) Patent Application Publication
(10) Pub. No.: US 2008/0073306 A1
(43) Pub. Date: Mar. 27, 2008

(54) Feeding Bottles

(76) Inventors: Mali Arel, Tel-Aviv (IL); Neta Mazor, Mazkeret Batia (IL)

Correspondence Address: Martin D Moynihan;PRTSI, Inc., P O Box 16446, Arlington, VA, 22215, US

(21) Appl. No.: 11/632,475

(22) PCT Filed:
(86) PCT No.: PCT/IL05/00745

Related U.S. Application Data
(60) Provisional application No. 60/587,503, filed on Jul. 14, 2004.
(60) Provisional application No. 60/623,232, filed on Nov. 1, 2004.

(51) Int. Cl. A61J 9/00; A61J 9/08

(52) U.S. Cl. 215/11.3; 215/11.1; 215/11.6

(57) ABSTRACT

An expandable container (EC) having a firm compartment and at least one foldable portion serves for storing instant food or drink for infants. The coverable aperture of the EC provides for hermetic sealing of a sterilized instant feed or drink and for further dispensing of various liquids for the preparation of food or drink, as well as for attachment of a nipple or a spout. A nipple retaining device (NRD) for feed bottles consists of a base rig attachable to the feed bottle and or the EC and an upper ring to which a nipple or a spout are attached. The upper ring is pivotally connected to the base ring and when closed, is securely locked to the base ring by means of a latch. The upper ring when sprung open provides for dispensing various liquids into the feed bottle and or the EC.

### TECHNICAL FIELD OF THE INVENTION

The present invention relates to bottle feeding and more particularly to feeding bottles and feed containers especially suited for feeding infants.

### BACKGROUND OF THE INVENTION

A significant effort is being invested in the development of methods and systems promoting the flexibility and convenience of bottle feeding and providing the level of hygiene as suitable for infants. U.S. Pat. No. 4,801,007 discloses a mountable nipple that provides for transforming a container of sterilized liquid, the container being made of plastic or laminated paper, into a feed bottle. However such a device is limited to such cases in which the suitable formulae are available in liquid form and are packaged accordingly. Furthermore the packaging of such liquids addresses mainly the integrity of the contained materials. Such packaging does not necessarily provide for dispensing additional ingredients to the baby.

U.S. Pat. No. 5,579,935 discloses a baby feed bottle with a disposable bag liner. The ready made feed which is packaged in such disposable bags or containers may assume various formulae and breast milk as well. However such bags or containers have to be stored at low temperatures for a limited time prior to use.

Both above mentioned examples mainly simplify the process of food preparation. On the other hand US patent application 20050040128A1 aims to simplify of the feeding process itself. This disclosure describes a feeding bottle having a flexible fluid container supported by a dispenser body and an elongated flow tube which allows for continuous feeding at any virtual orientation. However the process of food preparation when employing such a device suffers from the same limitations associated with common feed bottles.

### BRIEF DESCRIPTION OF THE DRAWINGS

FIG. 1 is a front side view of a nipple retaining device (NRD) in combination with a feeding bottle according to a preferred embodiment of the present invention;

FIG. 2 is a sectional frontal view of the NRD in combination with a feeding bottle of FIG. 1;

FIG. 3 is an isometric view of the partially opened NRD of FIG. 1;

FIG. 4 is an isometric view of a fully folded expandable container (EC) according to a preferred embodiment of the present invention;

FIG. 5 is an isometric view of a fully expanded EC of FIG. 4;

FIG. 6 is an isometric view of the partially expanded EC of FIG. 4 at an initial stage of expansion;

FIG. 7 is an isometric view of the partially expanded EC of FIG. 4;

### DETAILED DESCRIPTION OF THE PRESENT INVENTION

The present invention provides a method and systems especially suited for bottle feeding of infants. A nipple retaining device (NRD) is provided for use in combination with a commonly available feed bottle as well as with a novel expandable container (EC) as is described infra. The NRD of the invention facilitates an individual carrying a baby with one hand to prepare food or drink, in a feed bottle or in an EC, using the other hand. The EC of the invention is especially useful for outdoor use.

Nipple Retaining Device

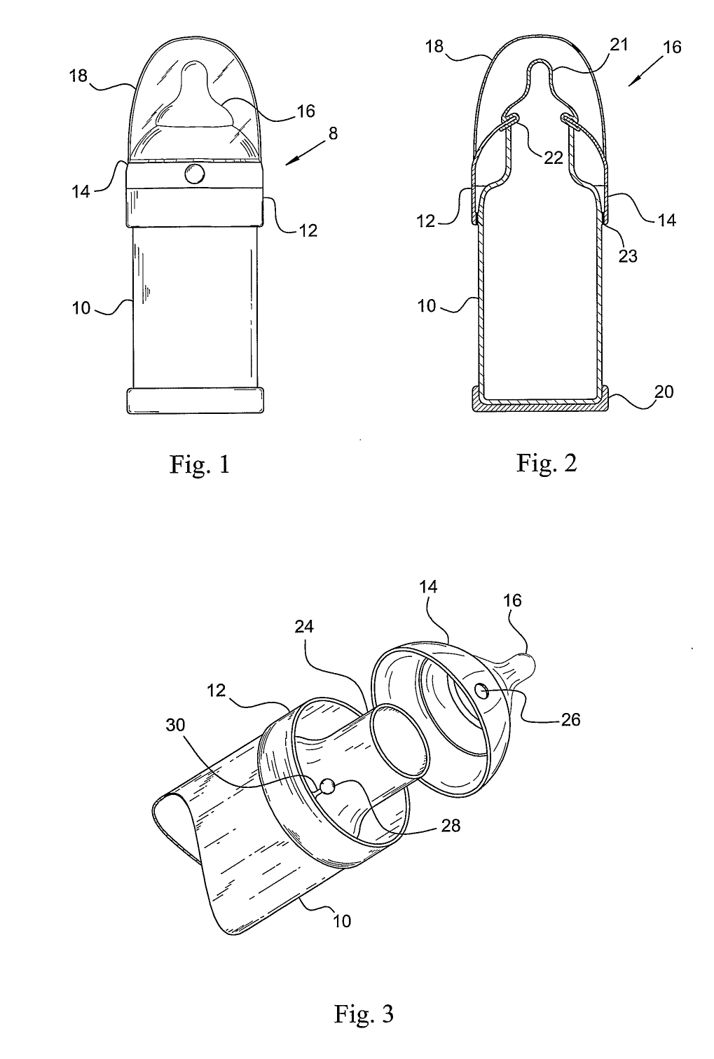

Reference is first made to FIGS. 1-2 in which a front side view and a frontal sectional view of a NRD in combination with a feed bottle according to a preferred embodiment of the present invention are respectively shown. For the purpose of simplicity same parts shown in different figures are indicated hereinafter with same numerals unless otherwise indicated. A NRD 8 is attached on top of a feed bottle 10. The NRD 8 consists of base ring 12 attached to the feed bottle 10 and an upper ring 14 to which nipple 16 is attached. A cover 18 is placed on top of the upper ring 14 for protecting the nipple from contaminants. An optional base plate 20 is attached to the bottom of feed bottle 10 for its stabilization. The feed bottle 10 and the cover 18 are typically made of transparent materials sustaining sufficiently high temperatures as required for sterilization. Suitable transparent materials are polyethylene, polypropylene, or other plastic resins employed in the manufacturing of feed bottles and or devices for storing food. Gradation marks, not shown, are optionally marked on a surface of feed bottle 10 indicating the volume of a contained liquid. Both rings of the NRD are typically made of the same material as the feed bottle is made of, whereas the nipple 16 and the base plate 20 are typically made of a flexible material such as latex or silicone rubber. As shown in FIG. 2, The nipple 16 has a mouthpiece 21 having a perforated surface at its top end, not shown, and a circumferential flange 22 located at its bottom. The base ring is threaded to facilitate fastening to the equivalent threaded surface 23 on the feed bottle. The base ring is either attached or formed as an integral part of the feed bottle.

Reference is now made to FIG. 3 in which an isometric view of a partially opened NRD according to a preferred embodiment of the present invention is shown. Base ring 12 is attached to the feed bottle 10 surrounding neck 24. Upper ring 14 is pivotally attached to base ring 12. Upper ring 14 is rotatable between a functionally closed and a functionally open position. In the closed position the upper ring is secured on top of the base ring 12 as is shown in FIGS. 1 and 2. In the opened position the upper ring 14 is rotated away from the base ring 12. At the closed position, the upper ring 14 is secured to the base ring 12 by means of a latch. Pawl 28 of the latch fits into notch 26 in the upper ring 14. The latch according to this preferred embodiment of the invention is biased into notch 26 by the biasing support 30. As the upper ring is pressed into the closed position, pawl 28 slides into notch 26 and circumferential flange 22 is pressed against the rim of neck 24. Hence the NRD becomes securely locked and the connection between the rim of the neck 24 and the nipple 16 is sealed off at this position. By pushing pawl 28 inwards, the pawl disengages from the notch 26 and the NRD can snap open by the force applied by the deformed flange 22 and or by means of a biasing spring. Subsequently, a solid instant feed or formula can be dispensed into the feed bottle and a measured portion of liquid such as water, milk and or any appropriate liquid, either warm or cold, is further dispensed into the feed bottle. Subsequently, the upper ring is forced back into the closed position. In the overall process by using the bottle of the invention, the preparation of the food in the feed bottle can be accomplished using a single hand. These activities include: (i) snap open the NRD, (ii) dispensing measured portions of dry instant feed and corresponding liquids, and further (iii) close the NRD, (iv) placing a cover, and (v) shaking the covered feed bottle for a better mixing of the various ingredients.

Expandable Container

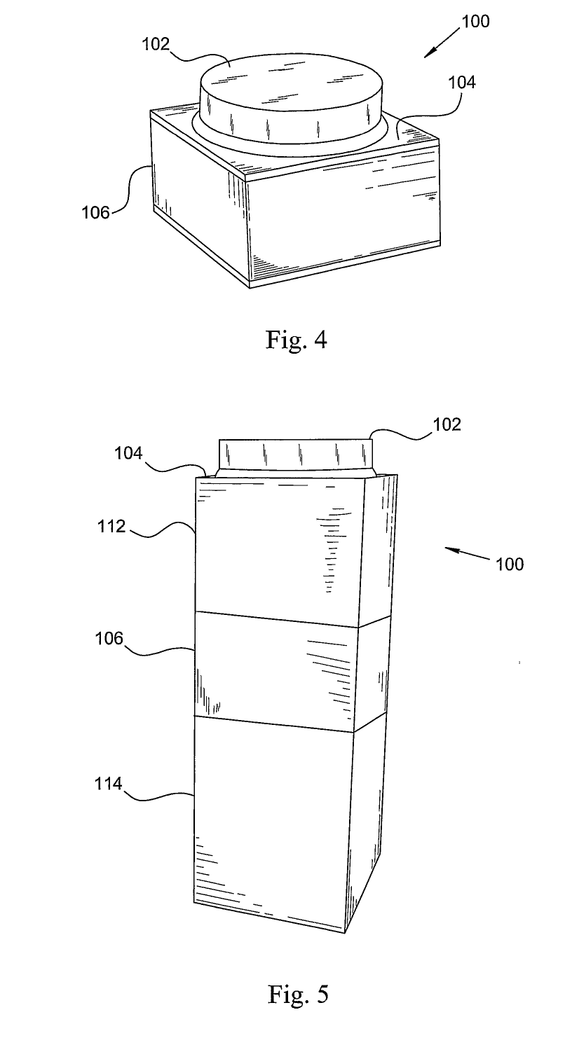

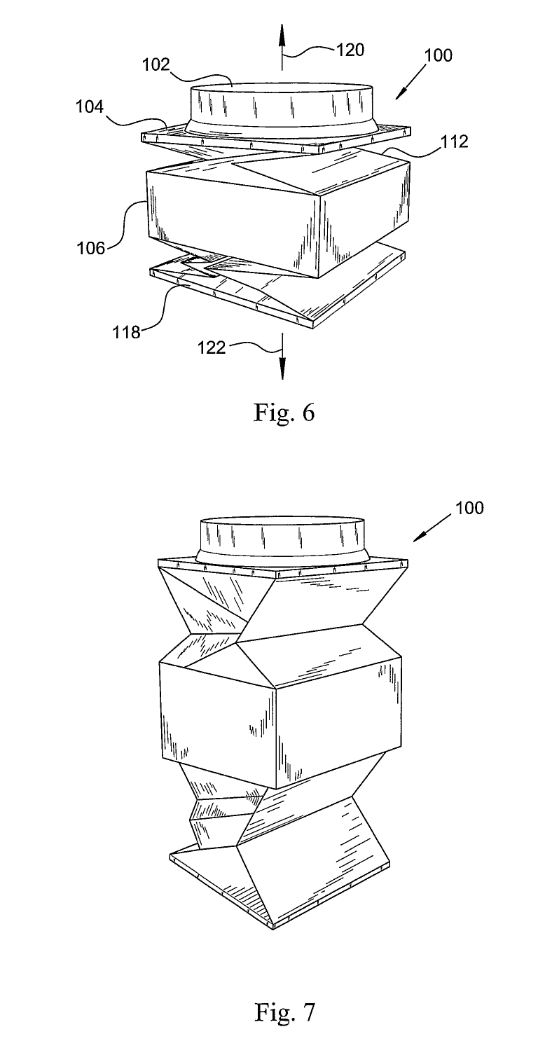

Reference is now made to FIGS. 4-7 showing an expandable container (EC) of the invention at different stages of expansion. In FIG. 4 an isometric view of a EC folded to the utmost is shown. EC 100 has a lid 102 which covers an aperture, not shown, located at the topside wall 104 of the EC. Topside wall 104 is located above a firm compartment 106. In FIG. 5 an isometric view of a fully expanded EC is shown. In FIG. 6 and FIG. 7 isometric views of a partially expanded EC are shown respectively. The EC further includes at least one foldable portion disposed between the topside wall 104 on the one hand and a firm compartment such as compartment 106 and on the other hand. For expanding EC 100, firstly lid 102 is slightly rotated to vent the lumen of the EC as it is being expanded. Then topside wall 104 at the top of the foldable portion 112 and the bottom wall of the EC sealing the foldable portion 114, which is appended beneath the firm compartment 106, are pulled apart as indicated by arrows 120 and 122 respectively. When all foldable compartments are unfolded, one common lumen is formed.

At a stage in which the EC is fully expanded the lid 102 is removed from the aperture and is replaced by a NRD of the invention having a nipple installed. Preparing food for a baby is accomplished by implementing a process such as described herein above. Firstly, the upper ring of the NRD is sprung open and measured portions of corresponding liquids are dispensed into the lumen of the EC. Then the upper ring is forced back into its locking position and the EC is shaken for a better mixing of the contained ingredients.

Optionally various types of instant food and or formulae and or instant drinks, which are suitable for mixing with compatible liquids, are hermetically packaged in an EC according to the present invention. Such instant food or drinks are sterilized and packaged in the EC prior to a stage of completely folding its upper foldable portion. ECs containing sterilized food or drink are useful for outdoor use. Alternately an instant feed and or additives are poured into the EC prior to the dispensing of the liquids. Following the dispensing of liquid the upper ring of the NRD is forced into the locked position, a cover is further placed on top of the NRD and the EC is shaken. At this stage the EC is ready for feeding. A spout, which is suitable for drinks such as hot chocolate, optionally replaces the nipple of the NRD of the invention. The NRD is optionally replaced by any nipple, or a spout, physically attachable.

The EC is typically made of foldable materials which are relatively firm and are commonly employed for storing instant food, such as laminated thin cardboard. Therefore the fully expanded EC is firm and stable when placed over an even surface. Optionally the foldable portions of an EC are flexible and are made of laminated paper and or plastic resins such as polyethylene. However, at least the firm compartment, the topside wall and bottom wall of an EC of the invention, are made of firm materials providing for hermetically sealing its content. Therefore the EC of the invention practically serves as a disposable feed bottle. Furthermore the folded EC provides for relatively long term storage of a food portion at an ambient temperature. Such features of the EC of the invention are especially suited for outdoor use.

1. A nipple retaining device (NRD) for feed bottle comprising:
a base ring attachable to said feed bottle;
an upper ring to which a nipple is attachable, wherein said upper ring is pivotally connected to said base ring;
a latch for securing said upper ring to said base ring, and
wherein said upper ring is rotatable between a closed position in which said upper ring is secured to said base ring and an opened position in which said upper ring is disengaged from said base ring.

2. A NRD for a feed bottle as in claim 1, wherein a circumferential flange of said nipple seals off the connection between the rim of the neck of said bottle and the nipple

3. A NRD for a feed bottle as in claim 2, wherein said base ring is screwable onto said feed bottle.

4. A method for preparing baby food in a bottle comprising:
a. snapping open a NRD by releasing a pawl securing an upper ring to a lower ring, both of said NRD;
b. dispensing at least a measured portion of liquid into said feed bottle;
c. forcing said upper ring into a closed position thereby closing said NRD, and
wherein said upper ring is pivotally connected to said base ring.

5. A method for preparing baby food in a bottle as in claim 4, further comprising dispensing dry baby food into said feed bottle.

6. An expandable container (EC) for instant feed especially suited for feeding infants comprising:
a coverable aperture located on top of said EC accommodated for attachment of a nipple;
at least one foldable portion;
a firm compartment appended to said at least one foldable portion,
wherein a volume of said EC is changeable between a first value in which said at least one foldable portion is folded and a second value in which said at least one foldable portion is fully expanded.

7. An expandable container (EC) for instant feed especially suited for feeding infants as in claim 6, also including a nipple retaining device (NRD), wherein said NRD comprises
a base ring attachable to said aperture;
an upper ring at which a nipple is attachable, wherein said upper ring is pivotally connected to said base ring, and
wherein said upper ring is rotatable between a first position in which said upper ring is placed on top of said base ring and a second position in which said upper ring is disengaged from said base ring.

8. An expandable container (EC) for instant feed especially suited for feeding infants as in claim 6, also including a nipple attached to said aperture

9. An EC for instant feed especially suited for feeding infants as in claim 6, in combination with a spout-attached to said aperture.

10. An EC for instant feed especially suited for feeding infants as in any of claim 8 in combination with a cover placed on top of said aperture.
